(19) United States
(12) Patent Application Publication
(10) Pub. No.: US 2002/0161665 A1
(43) Pub. Date: Oct. 31, 2002

(54) Method for placing orders for masks used to fabricate semiconductor devices

(75) Inventors: Satoshi Aoyama, Tokyo (JP); Yuko Kikuta, Tokyo (JP)

Correspondence Address: MCDERMOTT WILL & EMERY, 600 13TH STREET, N.W., WASHINGTON, DC, 20005-3096, US

(73) Assignee: MITSUBISHI DENKI KABUSHIKI KAISHA

(21) Appl. No.: 09/983,214

(22) Filed: Oct. 23, 2001

(30) Foreign Application Priority Data
Apr. 27, 2001 (JP) 2001-132359

(51) Int. Cl. G06F 17/60

(52) U.S. Cl. 705/26

(57) ABSTRACT

A semiconductor device manufacture provides beforehand to a mask maker a plurality of specifications of masks which are related to a grade of the mask. The mask specifications are stored in a storage device of the mask maker. Upon placing an order for a specific mask, the semiconductor device manufacturer, sends to the mask maker a name of the specific mask and a symbol indicative of a grade of the specific mask (or a name of a mask including a grade symbol) by way of the Internet, and transmits to the mask maker drawing data and layout data by a network.

### BACKGROUND OF THE INVENTION

1. Field of the Invention

The present invention relates to a method for placing orders for masks used to fabricate semiconductor devices.

2. Description of the Related Art

The process of semiconductor device fabrication involves producing photo masks that serve as photographic plates reflecting data about circuit patterns created by design engineers using CAD. The photo mask patterns thus prepared are transferred to a wafer to produce circuits thereon.

A set of about 20 to 50 photo masks is prepared for each type of semiconductor device to be fabricated. Each photo mask is furnished with an identification mark (called the mask name hereunder) to clarify to which semiconductor device it belongs. The mask name is generally given as a combination of alphanumeric characters.

Photo masks are produced not by semiconductor device manufacturers but by mask makers dedicated exclusively to mask fabrication. Semiconductor device manufacturers place orders with mask makers for photo masks necessary for fabricating specific semiconductor devices.

FIG. 1 is a schematic view illustrating a conventional method of placing orders for photo masks. A semiconductor device manufacturer, when placing an order for a photo mask, creates three kinds of data: a specification 1 that defines specifications of the photo mask in question, CAD data (drawing data 2) that represent mask patterns, and layout data 3 that designate pattern layout on the mask. As indicated by arrow 1A in FIG. 1, the specification 1 is dispatched to the mask maker in the form of sheets of paper; it may also be transmitted to the mask maker as electronic data over the Internet. The drawing data 2 and layout data 3 are sent to the mask maker over dedicated lines, not shown, as indicated by arrows 2A and 3A.

The specification 1 comprises all necessary information for specifying the mask structures: information that designates degrees of precision of element sizes and positions, their tolerances and their permissible defects; information about mask performance such as transmittance and reflectance levels of light shield films and, in the case of HT (half-tone) masks, their phase angles and transmittance levels; and other information including mask board sizes, pattern magnifications, any need for pellicles to prevent foreign matters from sticking to the pattern surface, materials of the light shield films, the type of wafer resist as positive or negative, and a mask shrink rate.

As indicated by arrow 1B, the contents of the specification 1 are translated by the mask maker into an in-house specification 11 in keeping with the mask maker's internal practice. Thereafter, as indicated by arrows 11A and 23A, a mask fabrication process 4 is started on the basis of the in-house specification 11 as well as the drawing data 2 and layout data 3. The process 4 terminates when a mask 5 is completed as indicated by arrow 4A.

The conventional method for placing orders outlined above requires time and effort on the side of the semiconductor device manufacturer because of the need to prepare specifications for each photo mask. The steps involved up to placing orders are complicated and tend to provoke mistakes and lapses. This can lead to falsely indicated specifications resulting in defective products.

Mask makers, for their part, must translate the specification of each ordered photo mask into in-house standards. That means they are just as preoccupied dealing with received orders as semiconductor manufacturers placing their orders. In expending time and effort, the mask makers under pressure are also prone to mistakes that can lead to falsely described in-house specifications resulting in defects.

### SUMMARY OF THE INVENTION

The present invention has been made in view of the above circumstances and provides a method for placing orders for photo masks or other masks without the need for preparing mask specifications.

According to the present invention a device manufacture provides beforehand to a mask maker a plurality of specifications of masks which are related to a grade of the mask. The mask specifications are stored in a storage device of the mask maker.

According to a first embodiment, the semiconductor device manufacturer, upon placing an order for a specific mask, transmits to the mask maker a name of the specific mask and a symbol indicative of a grade of the specific mask by way of the Internet, and transmits to the mask maker drawing data and layout data by a network.

According to a second embodiment, the semiconductor device manufacturer transmits a name of a mask on order including a symbol indicative of a grade of the mask by way of the Internet, and transmits drawing data and layout data by a network.

Other objects and advantages of the invention will become apparent from the examination of the present disclosure.

### BRIEF DESCRIPTION OF THE DRAWINGS

The present invention will be more apparent from the following detailed description, when taken in conjunction with the accompanying drawings, in which;

FIG. 1 is a schematic view illustrating a conventional photo mask ordering method;

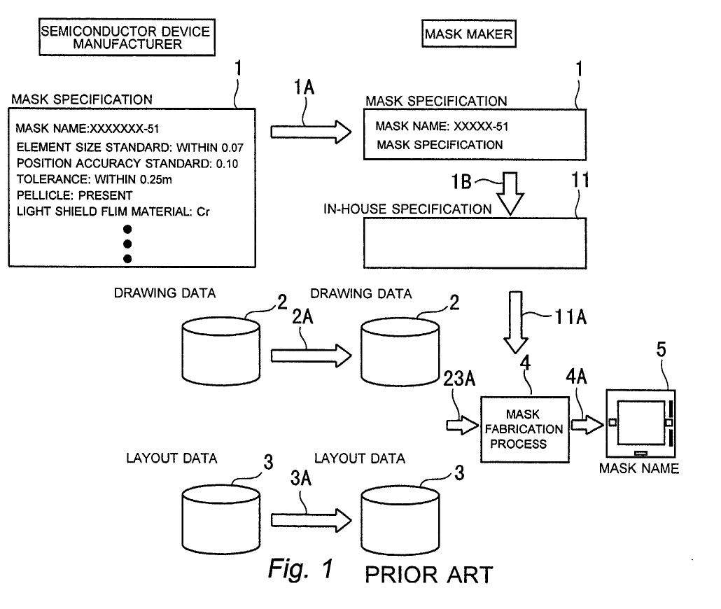

FIG. 2 is a schematic view outlining an ordering method practiced as a first embodiment of this invention; and

FIG. 3 is a schematic view depicting an ordering method practiced as a second embodiment of the invention.

### DESCRIPTION OF THE PREFERRED EMBODIMENTS

First Embodiment

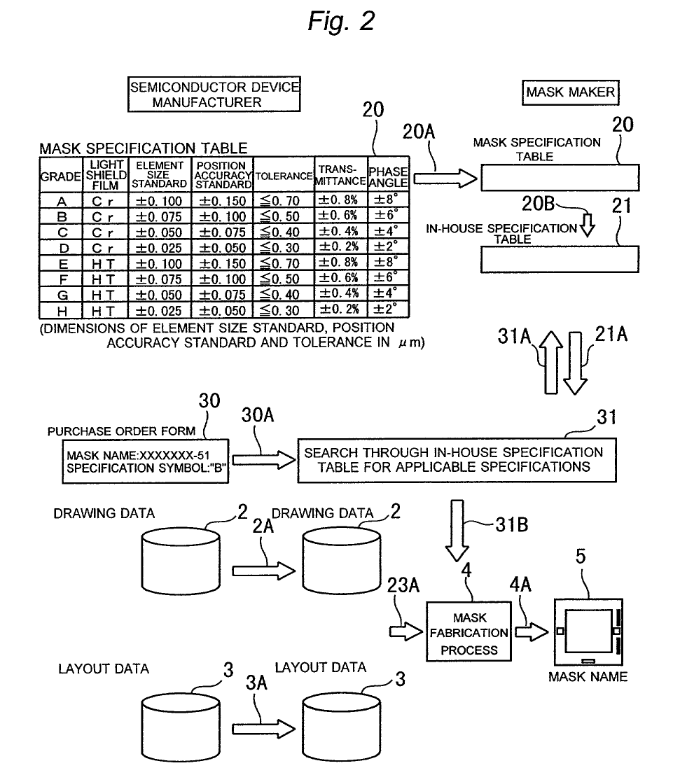

FIG. 2 outlines an ordering method practiced as the first embodiment of this invention.

In FIG. 2, a mask specification table 20 is prepared by a semiconductor device manufacturer that places orders for photo masks with a mask maker. The table 20 lists specifications of photo masks used by the semiconductor device manufacturer in producing all semiconductor devices. The listed specifications are grouped (indicated by symbols A, B, C, etc.) typically by item, grade and other yardsticks. The manner of grouping the specifications, their contents and the like shown in FIG. 2 are only an example and are not limitative of the invention.

With the first embodiment, the semiconductor device manufacturer transmits the specification table 20 only once to the mask maker over the Internet, as indicated by arrow 20A. The mask maker translates the transmitted specifications in the table 20 into an in-house specification table 21 in accordance with internal standards as indicated by arrow 20B. The translated table 21 is placed beforehand in a storage device, not shown. When placing orders for photo masks, the semiconductor device manufacturer prepares a purchase order form 30 designating a mask name and a mark indicative of the grade of each mask, and transmits the order form 30 to the mask maker over the Internet as indicated by arrow 30A. The mask name may illustratively be a combination of alphanumeric characters. The mask grade may be given typically by a symbol of an alphabetical character, “A” representing the highest grade in alphabetical order of the symbols.

Drawing data 2 and layout data 3 are transmitted to the mask maker over a dedicated line, not shown, as indicated by arrows 2A and 3A. Drawing data 2 and layout data 3 may be transmitted by the Internet.

Upon receipt of the purchase order form 30, the mask maker searches the stored in-house specification table 21 as indicated by arrow 31A for internal standards corresponding to grade“B” specified in the order form 30 as indicated by arrow 21A. The corresponding specifications are retrieved and employed, along with the drawing data 2 and layout data 3, to carry out a mask fabrication process 4. The process 4 is continued until a mask 5 is completed as indicated by arrow 4A.

The first embodiment of this invention simplifies tasks of the semiconductor device manufacturer transmitting the specifications upon placing orders with the mask maker. Simplifying the ordering chores helps the semiconductor device manufacturer minimize mistakes and lapses in preparing and sending the specifications to the mask maker. The mask maker, given the order, automatically searches for and retrieves the corresponding in-house specifications before proceeding with unattended mask fabrication accordingly. This makes it possible for the mask maker to eliminate human errors. As a result, the efficiency of the entire process for ordering photo masks is improved.

Second Embodiment

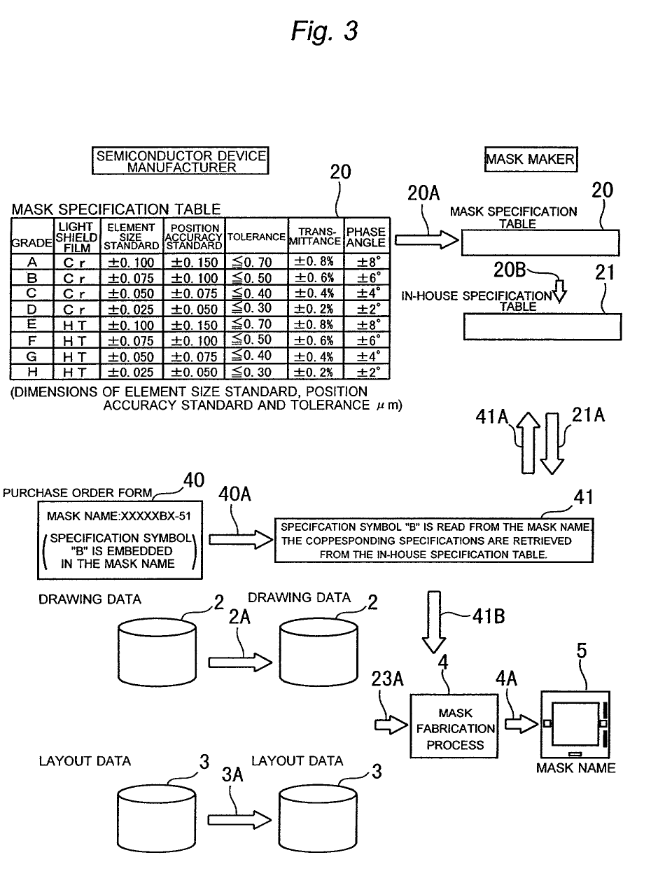

FIG. 3 depicts another ordering method practiced as the second embodiment of the invention.

What makes the second embodiment different from the first is that a symbol indicative of the mask grade is embedded in the mask name. When placing an order with the mask maker, the semiconductor device manufacturer transmits the mask name alone; all other steps are the same as those in the first embodiment. Illustratively, as shown in FIG. 3, a purchase order form 40 prepared by the semiconductor device manufacturer may have a symbol“B” indicating the mask grade embedded in the mask name in its sixth character position. The mask name containing the grade symbol is transmitted to the mask maker over the Internet as indicated by arrow 40A.

In turn, the mask maker picks up the mask grade“B” from the mask name in the transmitted order form 40. Accordingly, the mask maker searches the previously stored in-house specification table 21 for the internal specifications corresponding to the designated grade“B” as indicated by arrow 21A.

The subsequent mask fabricating steps are the same as those of the first embodiment.

The second embodiment of this invention supplements the benefits of the first embodiment with another one permitting verification of the grade for mask fabrication (i.e., mask quality) by a mere glance at the mask name given to the mask in question.

What is claimed is:

1. A method for placing orders with a mask maker for masks used by a semiconductor device manufacturer to fabricate a semiconductor device, the method comprising the steps of:
storing a plurality of specifications of masks in a storage device of the mask maker, each mask specification being related to a grade of the mask;
transmitting, from the semiconductor device manufacturer to the mask maker, a name of a mask on order and a symbol indicative of a grade of the mask by way of the Internet, and drawing data and layout data by a network, thereby placing an order for a specific mask.

2. A method for placing orders with a mask maker for masks used by a semiconductor device manufacturer to fabricate a semiconductor device, the method comprising the steps of:
storing a plurality of specifications of masks in a storage device of the mask maker, each mask specification being related to a grade of the mask;
transmitting, from the semiconductor device manufacturer to the mask maker, a name of a mask on order including a symbol indicative of a grade of the mask by way of the Internet, and drawing data and layout data by a network, thereby placing an order for a specific mask.
